(19) United States
(12) Patent Application Publication
(10) Pub. No.: US 2018/0075379 A1
(43) Pub. Date: Mar. 15, 2018

(54) METHOD FOR RISK-MANAGEMENT OVER LIFECYCLE OF COMPLEX PRODUCTS AND PROCESSES

(71) Applicant: 4Tune Engineering Ltd, Lisboa (PT)

(72) Inventor: Jose C. MENEZES, Lisboa (PT)

(21) Appl. No.: 15/422,084

(22) Filed: Feb. 1, 2017

(30) Foreign Application Priority Data
Sep. 14, 2016 (PT) 109618

(51) Int. Cl. G06Q 10/06; G06N 5/02

(52) U.S. Cl. CPC G06Q 10/0635; G06N 5/022

(57) ABSTRACT

A method for building risk-management workflows (‘Step A’), comprising several risk analysis tools seamless integrated (‘Step B’), to be applied to process design, process and equipment qualification, manufacturing stages and supply management (‘Step C’) of multi-step processing of chemical, pharmaceutical or biologic products (‘Step D’), for risk identification, assessment, mitigation and management over lifecycle (‘Step E’), thus supporting ongoing process verifications, product quality reviews, and knowledge-based process and product continuous improvement (‘Step F’). Workflows (‘Step A’) can be specific of certain stages (‘Step C’), products (‘Step D’), production equipment or facilities used to produce products, but can and should be combined to support the lifecycle management aspects of steps ‘E’ and ‘F’. The use of workflows (‘Step A’) with ‘Step B’ features combined, supports the type of activities in steps ‘E’ and ‘F’, provides a knowledge-management framework (‘Step F’) applicable across multiple products and platform technologies, that supports a science-based justification to decisions taken at defined lifecycle stages (‘Step C’).

### CROSS REFERENCE TO RELATED APPLICATION

This application is based on and claims the priority of Portuguese Patent Application No. 109618 filed on Sep. 14, 2016, the content of which is hereby incorporated by reference.

### FIELD OF THE INVENTION

The invention generally relates to methods for performing risk-management over lifecycle of complex products and processes, so that a science-based justification is captured at any moment of their lifecycle, and used to support not only late stage process validation but also ongoing process verification and improvement activities, with the aims also to support very high-levels of regulatory compliance.

### BACKGROUND

The aim of this filing and related innovation aspects herein, are associated with a breakthrough in (1) clarity (how-to) and (2) purpose (what-for) of risk management over lifecycle, for complex products and processing industries.

That is accomplished through a unique set of new practices and new methods applied to risk management. Established risk-analysis techniques are combined in a different way to produce workflows that transition the teams from stage to stage and create a knowledge management (KM) framework supporting risk management activities. The new practices expand the power of risk-assessments done previously with ‘one tool at one particular moment in time, on a process’ and enable ‘lifecycle risk-assessments’. Reevaluating risks over lifecycle and using new methods to compare several risk profiles, forms the basis of ongoing process verification (OPV), of continuous process and product improvement (CI). OPV and CI are two essential aspects of KM and of ‘learning-organizations’.

The novelty in the ‘new methods and practices’ is in (1) the seamless integration of different methods and techniques in workflows that step-wise transition the risk-management team from risk-identification to risk-assessment to risk-mitigation over lifecycle; (2) representing and locating risks through a process ontology and a process map, respectively; (3) the knowledge-management framework documenting the context of each critical lifecycle moment; (4) the enhanced science-based justification obtained from (1) through (3) to support decisions related to poorly understood systems; (5) the way aggregated knowledge from different subject matter experts (SME) is ‘harvested’ and used over lifecycle; (6) the way subjectivity and consistency of rankings from different teams involved over lifecycle for the re-evaluation of the same risks and failure modes is overcame; (7) how through the previous capabilities improved strategies to risk-control or mitigation can be derived to support manufacturing excellence (viz., OPV and CI); and (8) how the KM framework created enables incremental steps in a particular process and product over lifecycle, and also disruptive improved designs and operating options within a specific technology platform (e.g., new products using similar processing components previously considered, but in very different arrangements).

### STATE OF THE ART REVIEW

In 2004 the US Food and Drug Administration launched an initiative called Pharmaceutical cGMPs for the 21st Century—A Risk-Based Approach. Several documents from FDA, the European Medicines Agency (EMA) and the international Conference on Harmonization (ICH) over the following decade evolved. that earlier vision promoted by FDA. In 2011 FDA launched a new concept of process validation over lifecycle, that invoked to three stages—process design (I), qualification at-scale (II) and. commercial manufacturing (III)—with continued process verification taking place during stage III. EMA called ‘ongoing process verification’ (OPV) to FDA's stage III continued validation activities.

The concepts of process development and manufacturing the pharmaceutical industries with risk-based approaches, appeared for the first time in ICH Q9 (2005). ICH Q11 (2012) and ASTM 2500-07 (2012) allude to both quality risk-management and the need to revisit over lifecycle the risks involved as a way to secure continuous improvement and a compliant & validated process state. None of these documents ever mentions (1) risk-management as an enabler to knowledge-management, (2) risk-tools being integrated and interconnected, of (3) workflows for specific lifecycle states. In 2015 the EU revised the GMP Directives (Good Manufacturing Practices, Annex 15) and introduced risk-management as a new GMP requirement to ensure product quality and hence safety and efficacy.

The use of knowledge-management and quality risk-management (QRM) in the pharmaceutical industries have been thoroughly reviewed by Menezes et al. (2017). One findings was that risk-management tools can be used to harvest prior-knowledge required by KM and that an effort to support continuous improvement activities over lifecycle requires both QRM and KM elements to be intertwined. From here, it is possible to state that a science-based (KM) partial description of very complex processes can be build retrospectively using QRM elements, as claimed here.

Chemical and most other processing industries are familiar for almost 50 years with the most important risk-management methods, but are strange to a strict systems-engineering approach based on lifecycle and continuous improvement strategies founded in the knowledge-management applied through risk-management practices.

No industry whatsoever, has yet made the proposition to connect different risk-management tools, define workflows particular to specific problems and their maturity (stage) not to mention applying such approach consistently over lifecycle. None has even solved the inconsistencies that most semi-quantitative risk tools have, with subjectivities from different teams assessing the same risks in different occasions. None has ever solved the aspect of deriving the criticality threshold (value above which risks are considered unacceptable and need to be addressed) from the intrinsic risks assessed and not from an arbitrary value imposed regardless of risks and the situation being evaluated.

The proposed approach advances in all the above aspects risk-management and brings a science-based aspect to it, making a clear connection to knowledge-management and operational performance over lifecycle.

A thorough search of patents in the risk-management domain that could collide with ours, revealed several patents. None, however, contains the elements indicated in the six-stages and associated claims indicated herein. The top most closely associated patents to our submission are discussed below.

U.S. 20120191466 A1—Systems and Methods of Pharmaceutical Information Management, is a patent describing a system for administering a mentoring program to a user, comprising a user interface having a health risk assessment for providing a health risk assessment questionnaire to the user and a processor in communication with the user interface for generating alerts based on the received responses. The system generating risk scores associated with the user, then generating a report that is based on the alerts and/or the risk scores, and providing a notification to a health care practitioner once the report has been generated. The system further provides communications between the user interface and a health care practitioner interface to generate and communicate notifications associated with a mentoring program between the user and the health care practitioner. It is therefore not overlapping with any of the claimed novelty aspects in our own submission.

U.S. 20040117126 A1—Method of assessing and managing risks associated with a pharmaceutical product, is a patent describing a method for identifying and assessing risks associated with a pharmaceutical product. The method comprises identifying adverse events caused by a pharmaceutical product, identifying the failure modes in the process of using said pharmaceutical product that exposes patients to said adverse events, quantifying the potential effects of said failure modes to conduct a hazard assessment for purposes of evaluating the need to mitigate the failure mode, and designing a risk management program to manage the adverse events. It includes a method for creating effective interventions for use in mitigating the risk of the pharmaceutical product. Namely, the creation of educational materials which are continually evaluated and revised to achieve an expected level of effectiveness on a target audience. It is non-trivial to generalize from a product and patient interaction, and a very limited use of disconnected risk-tools, the type of claims and novelty aspects in our own submission.

U.S. 20060010496 A1—Active and contextual risk management using risk software objects, is a patent describing a risk management system that includes a memory system containing a plurality of risk software objects, each of which represents a risk associated with an enterprise and which is configured to contain attributes and methods. A computer processing system may be configured to manage the software objects and the relationship. Relationships may also be with workflow processes. Numerous variations, as well as related processes and computer-readable media are also disclosed. Although the notion of workflow is invoked, its meaning is that specific of IT and of information workflow, not the alignment of specific methods to be able to cope with different tasks specific of each of the three main stages in a product lifecycle.

U.S. 20090070170 A1—System and method for risk assessment and management, is a patent disclosing a method for assessing and managing risks, that describes an algorithm for comparing computed risk results against acceptable and unacceptable criteria to determine whether the risk is tolerable, and hence to be managed with suitable control scenarios. Although it introduces a novel probabilistic framework for assessing the three risk descriptors (severity, occurrence, detectability) making up RPN (risk priority number) it has nothing in common to our submission. In fact, the most sensitive aspect would be if criteria derived to classify a risk as tolerable or not, would have overlapped with our own threshold computation, which is a derivation from the RPN profile as obtained for each specific problem. That is not the case.

U.S. 20110166871 A1—Integrated assessments, workflow, and reporting, is a patent about a risk assessment input terminal through which risk assessment information is entered for a plurality of patients using a risk assessment template. A care plan processor assembles intervention for the patients and stored in a patient file memory. Portions of a patient's care plan that are to be delivered to a patient each day are supplied over an electronic network to a patient terminal for display. Care plan professionals complete the open tasks or transfer open tasks to another care professional and close the completed tasks. A report generator generates various reports. This altogether has very little to nothing to do with our claims, both in terms of methods, tools, techniques and general workflow.

U.S. 20130080293 A1—Manufacturing supply chain management, this is a patent about managing a manufacturing supply chain to ensure compliance with industry-specific and federal standards from the time the material is supplied by a vendor to the time a product is provided to a customer. Some embodiments include a customer database, a vendor database, a risk management database, a validation database, etc. The databases store information associated with material vendors, customers, risk assessments, control parameters, and validation or qualification information related to the use of machines and manufacturing processes. This information is used to process a purchase order and ensure that a customer receives a corresponding quote fulfilling the order and including materials that are in compliance with the customer's own manufacturing and materials standards, as well as any relevant federal and industry-specific standards. The terms validation and qualification have a different meaning, a customer might be replaced by a product lot in this approach but no continuity and lifecycle management plan is invoked nor a different risk-methods are required or even interconnected.

U.S. 20140081652 A1—Automated Healthcare Risk Management System Utilizing Real-time Predictive Models, Risk Adjusted Provider Cost Index, Edit Analytics, Strategy Management, Managed Learning Environment, Contact Management, Forensic GUI, Case Management And Reporting System For Preventing And Detecting Healthcare Fraud, Abuse, Waste And Errors, this is a real-time Software as a Service application which interfaces and assists investigators, law enforcement and risk management analysts by focusing their efforts on the highest risk and highest value healthcare payments. It is aimed at targeting, identifying and preventing fraud, abuse, waste and errors prior to claim payment of health insurances. Our claims do not overlap with this patent as well.

Our invention relates to methods for performing risk-management over lifecycle of complex products and processes, creating a solid science-based justification to support validation, regulatory compliance and performance improvement activities. The above list of patents that fall on the healthcare and risk-management domains have no overlap with our claims.

### REFERENCES

### ICH Q9—Quality Risk Management Guideline (2005)

### FDA Process Validation Guidance (2011)

### ASTM 2500-07 Standard Guide for Specification, Design, and Verification of Pharmaceutical and Biopharmaceutical Manufacturing Systems and Equipment, (2012)

### ICH Q11—Development and Manufacture of Drug Substances (2012)

### EMA Process Validation (2014)

### EMA Annex 15 to Eudralex GMP Vol 4. (2015)

A Lifecycle Approach to Knowledge Excellence in the Pharmaceutical Industry, Eds. N Calnan, M Lipa, P Kaine, J C Menezes—Taylor & Francis (in press, 2017).
B Berry “There is a Relationship Between Systems Thinking and W. Edwards Deming's Theory of Profound Knowledge.” www.berrywood.com (last view Sep. 7, 2016).

### SUMMARY OF THE INVENTION

The aim of this filing and related innovation aspects herein, are associated with a breakthrough in (1) how-to (clarity) and (2) what-for (purpose) of Quality, Safety and Efficacy Risk Management should be used, for complex products manufactured by multi-step processes from chemically complex or undefined feedstocks.

It embodies a methodology to achieve very high-levels of product Quality Risk Management at an organizational level, when performing over lifecycle identification, mitigation and management of risks to operators, business its operators and end-users.

Complex products are pharmaceuticals and its intermediaries, biologics, performance materials or chemical entities obtained by multiple processing steps interconnected—characterized by multiple quality specifications of chemical, physical or biological nature (quality attributes)—that: (1) are required to meet multiple quality, safety, efficacy or performance end-specifications for their intended human or animal use; (2) are subject to extensive regulatory oversight; and (3) have long development cycles in comparison to their commercial life (typically 20-50% of their entire lifecycle is used for development). These complex products are produced through complex systems characterized by multiple processing steps (unit operations); using chemically complex or incompletely defined raw-materials as feedstocks to that process.

A complex system where:
a. multiple process steps could be executed in sequence or in parallel,
b. overall system variability is greater or smaller than the sum of its sub-processes variability, due to interactions among risk-related factors changing variability,
c. there is a memory effect, i.e., a risk-based failure mode originating variability at one point can trigger other risks and variability at subsequent process locations,
d. a change in performance at one location can trigger a performance or quality risk in the outputs of the system,
e. its topology may evolve over lifecycle (e.g., type and number of steps),
f. the output specifications may be redefined over lifecycle and the process used to realize the output may require minor adjustments or major changes,
g. component processes, their equipment, allocated resources, inputs to each process step (controlled and uncontrolled), operating constraints and policies have to be taken into account;

The complex product's quality is completely defined by the complex system of manufacturing (i.e., Quality can be ensured by Design, QbD). Safety and Efficacy risks to product's end-users should be assessed and managed as risks impacting the intended product quality, since quality defines and is a surrogate of product safety and efficacy.

The core innovative aspect of the methodology is that it establishes an event-centric approach to risk management that considers simultaneously product lifecycle (i.e., time-dimension from development to industrialization to commercial history) with process topology (i.e., end-to-end causality mapping supported by a process ontology valid also across multiple process versions or topologies and kept through the risk management activities and tools). In that way, the time and science-based justifications are encapsulated in the event, can be retrieved and made available not as sources of information but of knowledge for system and organization improvement (i.e., incremental with the same process/product technology-platforms or disruptive outside that portfolio platform).

The event-centric approach to risk management presented contains the necessary and sufficient elements to ensure optimal performance for a whole system or organization (cf. “system of profound knowledge”, Deming), namely:
a systems approach,
knowledge of variation,
the means for continual improvement and
consideration of human aspects impacting performance.

Such methodology can be used on an entity level (viz., equipment, processing step, production line, entire site, supplier qualification and supply chain), or on a combination of entities (i.e., a system or organization).

No single risk tool alone is able to support all aspects of QRM performed end-to-end and over lifecycle, for any complex process or complex product. QRM Workflows herein presented are tandems of specific tools chosen for particular QRM tasks (risk identification, assessment, mitigation or their combination), to be applied to specific process-related entities (end-product, equipment, facility or feedstock suppliers) and to specific lifecycle stages (entity design, qualification or commercial exploration). Tools in workflows are applied in a predefined and intended order to formalize QRM activities and to ensure optimal QRM outcomes—for that purpose such tools have to be seamless integrated to each other. An example is given in PREFERRED EMBODIMENTS FIG. 2.

It is also described a procedure for building the QRM workflows, comprising a top-down approach, starting with the desired quality target product profile (QTPP); followed by trial-and-error designs or informed first-guesses from subject matter experts possessing prior-knowledge on process design options that deliver the required product with the desired QTPP; an end-to-end mapping of the entire feedstock-to-product sequence; creating design, process qualification or commercial lifecycle ontologies through comprehensive listing of all inputs and outputs at each processing step in the manufacturing sequence; mapping and analyzing the causality between inputs and outputs per unit operation or for the entire sequence; deriving failure modes created from such causality; creating risk-ranking and profiling evaluation steps; deriving a problem-specific criticality threshold and using it as criteria for selecting failure modes requiring mitigation and active control strategies; formulating control action plans; monitoring the execution and completion of such plans; deriving improvement opportunities; documenting all steps with supporting evidence and the decision-making context that led to formulating the actions in the QRM plan; ensuring future use in same product (periodic risk review) or in comparable products/processes of the enhanced science-based justification obtained from QRM activities and to support decisions related to poorly understood systems for which acceptable residual risks exist (Knowledge-Management). An example is given in PREFERRED EMBODIMENTS FIG. 2.

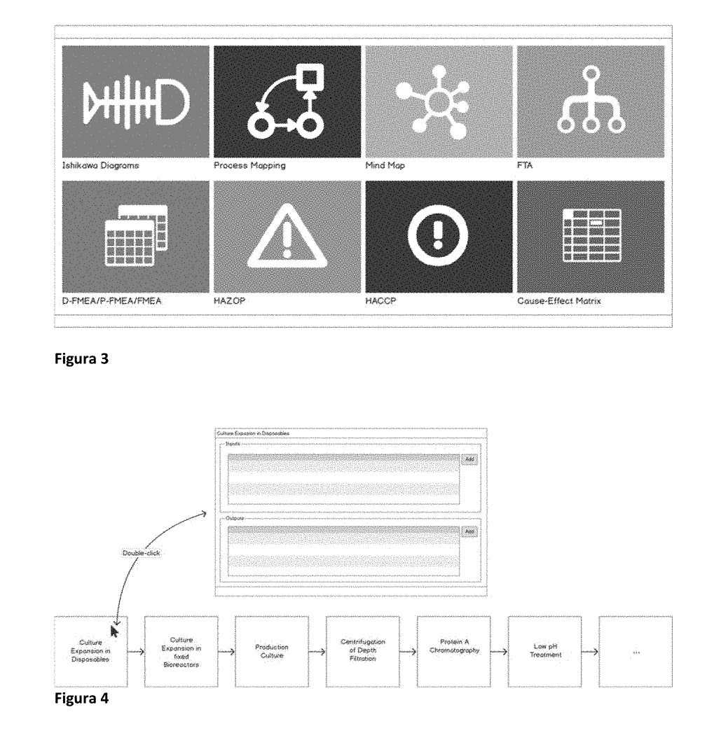

The tools in Workflows are interconnected and create also a seamless integrated method for QRM over lifecycle, that is able to identify, assess, rank, propose and manage control or mitigation actions; follow up with deployment, monitor improvements produced in the system's risk profile, and provide an evidence- and prior-knowledge driven support to all decisions, by using existing historical data and information collected on the system. An example is given in PREFERRED EMBODIMENTS FIGS. 3, 5 & 7.

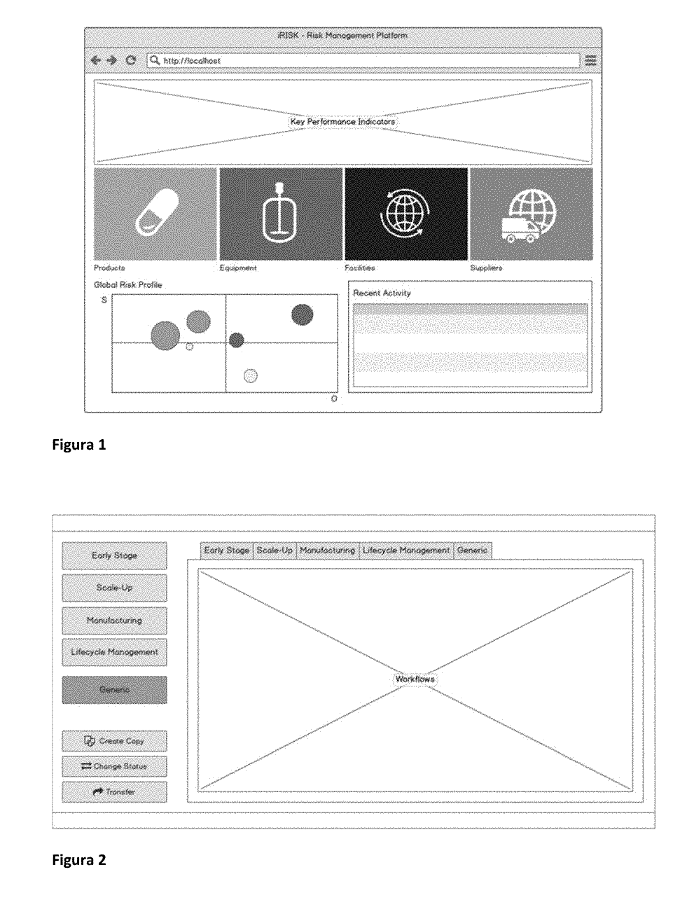

FIGS. 1-10 in PREFERRED EMBODIMENTS illustrate multi-step processing of chemicals, pharmaceuticals, biologic products or performance materials with the general method herein. FIGS. 3, 4, 6 & 10 in PREFERRED EMBODIMENTS illustrate applications to different lifecycle stages of the general method herein. FIGS. 5, 7-9 in PREFERRED EMBODIMENTS illustrate risk identification, assessment, mitigation and management over lifecycle of the general method herein.

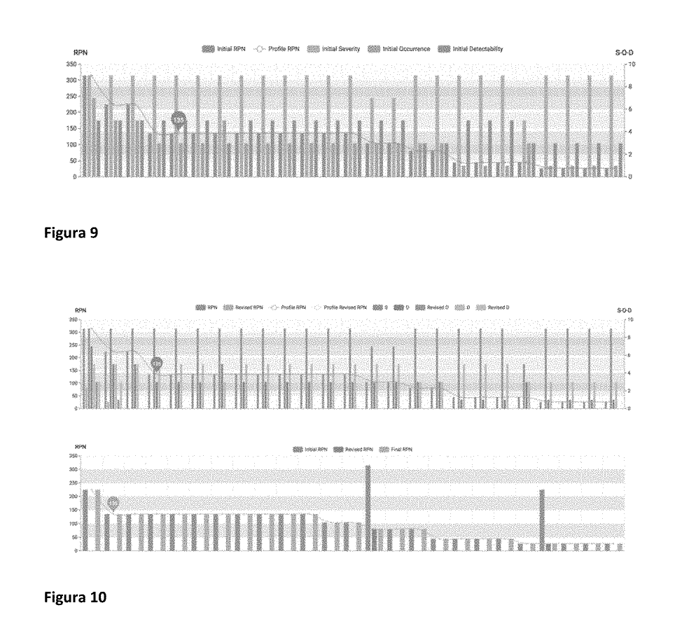

The methods here described also support ongoing process verification, in terms of compliance and validation risks, product quality reviews, and knowledge-based process and product continuous improvement. Examples are given in PREFERRED EMBODIMENTS FIGS. 2, 9 & 10.
a. A method to compare the risk profile of a complex system over lifecycle as changes and mitigation actions are introduced,
b. A method focusing on such risks, their magnitude of change and actions impacting that change, and their direct effects on product quality or related KPI targets;
c. A method to benchmark using a risk-based comparison, different process versions, different products sharing a similar process type, different sites manufacturing the same product with same or different process.

d. Conversely, a method capable of tracing particular distinct risks that discriminate two systems being benchmarked, back to specific system characteristics, by means of built ontologies for each system, therefore informing future designs or future improvement efforts of one particular design.

Quality Risk Management (QRM) of a complex product is therefore a holistic exercise on Quality, Safety and Efficacy risks (claims 1 and 3), performed end-to-end over the complex sequence (manufacturing sequence) and including all intended & unintended changes over its lifecycle (feedstocks, manufacturing, product controls) (claim 2).

The six-steps of our invention consist of the elements below:
Step A—A method for building risk-management workflows (claim 3 through 16);

Step B—comprising several risk analysis tools seamless integrated (claims 17 and 18);

Step C—to be applied to process design, process and equipment qualification and manufacturing and supplier stages (claim 2);

Step D—to be applied to multi-step processing of chemical, pharmaceutical or biologic products (claim 7);

Step E—for risk identification, assessment, mitigation and management over lifecycle (claims 19 and 20);

Step F—supporting ongoing process verifications, product quality reviews, and knowledge-based process and product continuous improvement (claim 21 through 23).

The above practices have behind each one new methods containing novelty aspects. The schemes in the figures on the next pages describe the new practices. Then reference to the methods and the novelty claims for each one is made.

FIG. 1 Risk Management End-to-End: Products, Equipment, Facilities and Suppliers Selection.

FIG. 2 Risk Management over Lifecycle: Workflows.

FIG. 3 Interconnected Risk Management Tools.

FIG. 4 Process Ontology Stage I.

FIG. 5 Brainstorming and Cause-Effect Analysis.

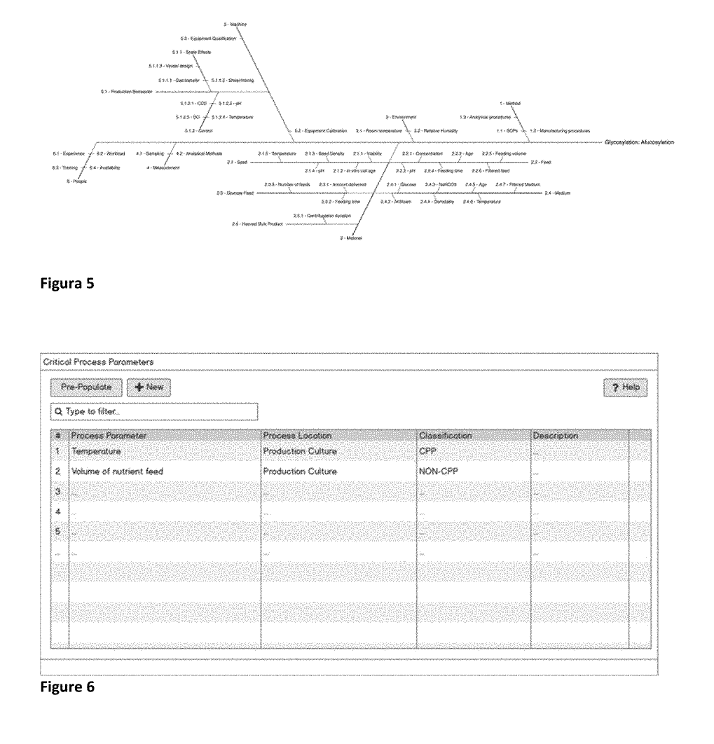

FIG. 6 Process Ontology Stage II.

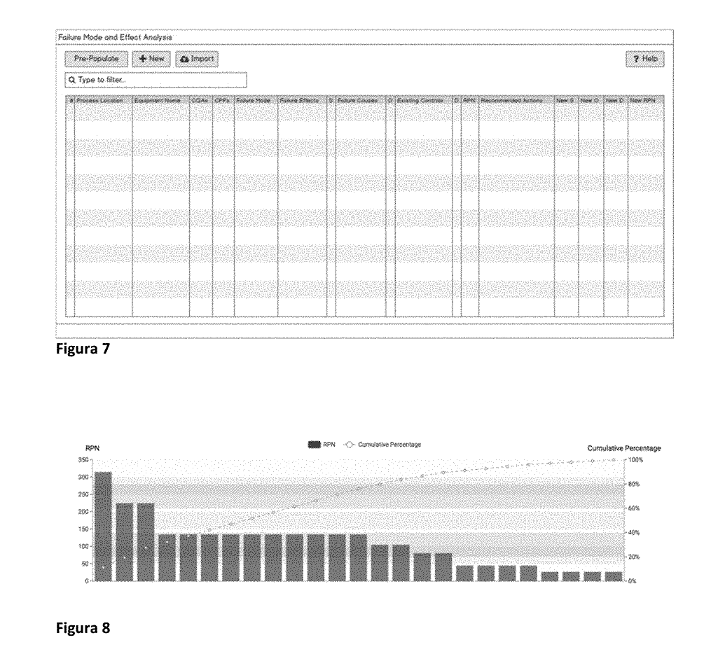

FIG. 7 FMEA: Failure Mode and Effects Analysis.

FIG. 8 RPN (bars) and Cumulative Pareto (line) profiles.

FIG. 9 RPN profile and associated severity, occurrence and detectability profiles.

FIG. 10 Process Ontology Stage III.

### DETAILED DESCRIPTION OF ILLUSTRATIVE/PREFERRED EMBODIMENTS

### FIG. 1

Risk Management End-to-End: Products, Processes, Facilities and Suppliers. The proposed methodology is completely general. It applies to (1) products, (2) processes—as individual steps, equipment elements, (3) their combinations such as a production line, a facility or a full site, and even (4) suppliers risk management and qualification.

Key innovative aspects. (1) methodology is general and applies equally to four very different entities (products, equipment, facilities, suppliers); (2) provides metrics that enable benchmarking of any of the previous four entities over lifecycle or across different instances of each entity; (3) benchmarking can be done not only via RPN profiles or trending of RPN thresholds, but through specific key-performance indicators, KPIs (e.g., related to yields, throughput, downtimes, equipment efficiency or utilization) and high-level visualization of entire RPN profiles for different entities (e.g., different products from same site or different sites producing the same product).

### FIG. 2

Risk Management over Lifecycle: Workflows. The core of our methodology is materialized through workflows that support the different stages of RM (risk identification, assessment and mitigation), each of these managed with different tools, used in a unique way. Although the tools are already existing, their interconnection is a novelty aspect, and the rationale behind the way their execution is done is unique.

Key innovative aspects. Three major and general capabilities, all containing novelty aspects, of the proposed workflow-based risk-management methodology, are:
(A) a process view of risks and the E2E type of assessment capabilities
   clarity on risk location, in terms of process step, equipment or element involved,
   root-cause or origin for the risks, in terms of causality, even when in a science-based way cause-effect might be poorly understood,
   what should be an adequate strategy to prevent/mitigate a particular failure mode and
   the capability of designing new or improved control strategies for existing risks
(B) a lifecycle management component
   comparing risk profiles over repeated assessments in a way that is robust to inconsistencies in ranking (e.g., due to team changes)
   establishing the capabilities of an ongoing process verification program, in terms of management of product-related quality risks (QRM) and
   supporting continuous improvement, in terms of process-related excellence
   enabling benchmarking capabilities, across manufacturing operations (similar/different product types, process versions, sites)
(C) a knowledge management component
   providing a clear location in the methodology for a facilitator-driven brainstorming and knowledge-harvest stage to collect prior knowledge and to align the risk management team members,
   providing the context and science-based justification for the rationale of specific failure modes, through domain public or corporate available documentation,
   driving consistency in failure modes description and rankings given by a knowledge-based assistant during the assessment stages and
   enabling a more agile use of platform knowledge in new processes/products.

### FIG. 3

Interconnected Risk Management Tools. Through workflows different tools can be assembled and interconnected in a logical sequence, to achieve a particular task. The proposed methodology is not limited to specific tools, but used the required tools for a particular goal. Below three examples are given of situations encountered during lifecycle and respective tools proposed for each:
the conceptual design stage of a product and associated manufacturing process
   the workflow should contain brainstorming tools (e.g., mind map), followed by process mapping, then causality analysis (e.g., Ishikawa), operability analysis (e.g., HAZOP) and criticality assessments (e.g., PHA or D-FMEA),
the process industrialization or performance qualification stage of a process
   will involve having the previous stage workflow completed, plus a reassessment of the preliminary hazard assessment, via PHA or P-FMEA
the ongoing process verification stage of an established commercial process
   will involve having the previous stages completed and a periodic review of FMEA-based risk register, to reevaluate the risk profiles and spot improvement opportunities.

Key innovative aspects are (1) the capabilities of aggregating and linking different tools to manage the transition needed from conceptual brainstorming to the design, qualification of prototype and commercial performance of an existing manufacturing operation; (2) the capabilities of the proposed way that the methodology is put together is logic and comprehensive from a science- and knowledge-based point of view; (3) that methodology works therefore E2E for each stage and over lifecycle from stage to stage, in a seamless way in terms of information flows; (4) the enabling characteristics built-in for benchmarking different assessments made over lifecycle; and (5) the intrinsic ability to reuse the design, industrialization and commercial manufacturing ‘learnings’ from one project into a next project, gaining in enhanced agility, speed, reliability and competitiveness across the entire product pipeline a company might have.

### FIG. 4

Process Ontology Stage I. This is the design stage, where for an existing process or for a new process, the conceptual mapping on which the whole risk-management exercise will be based. The level of detail and levels that won't be made visible, must be decided. For each process step or piece of equipment in a particular step, their inputs and outputs in the sense of pre-listing what is observed and can be used later for control, is captured.

Key innovative aspects are therefore (1) the creation of a visual map to which risk assessment items can be clearly referred to later on (such as failure modes); (2) the creation of lists of all inputs and of all outputs, for all unit operations or process steps put back to back and from end to end; (3) creating the capabilities for incremental improvement (keeping all aspects of the ontology intact) or disruptive improvement through changes in the ontology (e.g., removing or replacing processing steps); (4) building an ontology consistent across the different risk management activities.

### FIG. 5

Brainstorming and Cause-Effect Analysis. An Ishikawa diagram, also called a fishbone diagram, can be used to collect potential root-causes for failure modes affecting a particular quality attribute (QA). The proposed methodology makes use of visual techniques for aligning the risk assessment team and to comprehensively capture all possible sources of risks. Instead of committing immediately to an FMEA, the formal risk-assessment exercise is guided through gradual and continuum way that is logic and interconnected. After mapping the elements in the entity (e.g., unit operations in a process), after collecting for each of those elements the inputs and outputs (e.g., for each processing step) and after ranking which outputs are likely to be critical to end result (e.g., end-product originating from the process), a deeper consideration of root-causes for different FMs is made, prior to any FMEA. The use of Ishikawa diagrams, one for each CQA, and of cause-effect matrices are very effective ways to capture potential FMs.

Key innovative aspects. (1) Linkage between a pre-defined level of detail in the Ishikawa diagram (main branches only or main and sub branches) for each quality attribute and the resulting FMEA table, enabling the later to be pre-populated by the former; (2) a step-wise progress from the early brainstorming stages, through more comprehensive consideration of potential risks, before arriving at a full FMEA; (3) a structure approach forcing the most complex aspects of FMEA to be de-constructed beforehand (viz., clarity as to antecedent-consequent, cause and effect).

### FIG. 6

Process Ontology Stage II. Listing of all process parameters (manipulated and uncontrolled inputs to process steps) existing end-to-end on the process. This list is part of the methodology and informs the control strategy (recommended actions derived from the FMEA stage) of what leverages exist to achieve the required product quality management. The PP list captures through SMEs which of those parameters might be used to control product attributes, and therefore which are CPPs. There is a similar listing for all quality attributes related to in-process materials and end-product. The lists of CPPs and CQAs will, during the subsequent stage of causality analysis (through Ishikawa diagrams and different matrices), be the basis of a formal risk-assessment and of properly described failure modes, with a clear process location for the root-cause (monitoring) and a clear place for implementing the recommended action (control)—those two locations don't necessarily have to coincide.

Key innovative aspects are therefore (1) the creation of lists of all inputs and of all outputs, for all unit operations or process steps put back to back and from end to end; (2) creating the capabilities for incremental improvement (keeping all aspects of the ontology intact) or disruptive improvement through changes in the ontology (e.g., removing or replacing processing steps).

### FIG. 7

FMEA: Failure Mode and Effects Analysis. An FMEA table pre-populated from the previous step in the RA workflow (e.g., Ishikawa, product quality specifications or cause-effect analysis tables). Processing step where the failure mode takes place identified, FM cause and FM effect identified, documentation of existing controls and recommended actions, rankings for severity, probability of occurrence and detectability are introduced using pre-defined ranges specific of that risk-assessment, the resulting RPN and the partial result for the criticality of that particular FM is obtained as well. The rationale for a particular ranking given to S, O and D, or of a particular decision on the actions to be taken, can be detailed in reports that are added to the failure mode documentation (e.g., a CAPA, Corrective Action, Prevention Action report as PDF or a research report from a journal website). New failure modes can be added and the current FMEA table and associated RPN profile can be visualized during the FMEA assessment. If a particular unit-operation in the FMEA table involves a CPP or a CQA—i.e., a critical process parameter and/or a critical quality attribute, respectively—that particular process step or equipment will be involved in setting the manipulated CPP values and/or resulting CQA outcomes. This specific aspect is key to define how and where the failure effect detection should be achieved (observability) and how and where the control action should be aimed to avoid the undesirable effect (controllability). These capabilities are directly related with the claim that our methodology embeds the process ontology into the FMEA table mapping all risks and where their effect is manifested and where their respective control or mitigation action should be applied. An additional aspect of managing the actions plan is related how the FMEA is carried out in the proposed methodology: when more than one action per failure mode are needed, they are considered independently repeating the FM in the FMEA table as this facilitates action management.

As the proposed method will be applied by a company to its many different products and processes and since some of both share similarities, our methodology ties the ontology (process map, unit operations, inputs and outputs definition) with a knowledge management component enabling the FMEA stage to interrogate an existing knowledge-base of failure modes as a new FM is created.

The innovations we claim in regard to FMEA Tables: (1) connectivity with previous tools used in the RA workflow—i.e., using the capability to pre-populate the FMEA table with failure modes derived, for example, from an Ishikawa diagram (aka fishbone); (2) locating the failure mode in respect to the previously defined process map and specific process step involved ensures causality (root-cause identification) and recommended actions are aligned with existing/required observability and controllability aspects; (3) a prioritization of recommended actions and the follow up plan on their implementation, linking FMEA to the next workflow stage (viz., OPV and CI). Particular aspects on reporting the FMEA table and how to manage the cloning of existing FMs and/or entire FMEA tables are also supported in a particular software environment; (4) retrieving from a knowledge-based engine, FMs with similar keywords, thus speeding the FMEA stage, driving consistency in the ranking used and contributing to better management of the existing corporate knowledge about their platforms.

### FIG. 8

RPN (bars) and cumulative Pareto (line) profiles, serve as basis for defining the failure modes that need to be considered or that can be disregarded as acceptable risks. For example, the first two FMs make up the first 20% as shown by the Pareto's profile, indicating high risks related to these FMs need to be considered. Similarly, those making up any other cumulative amount (e.g., 80%) can be used as basis to set aside acceptable residual risks (e.g., last 20% of the Pareto profile will include the least important failure modes). From the bar and the line profiles a decision can be made on (1) unacceptable risks and identify the respective failure modes requiring consideration; and conversely on (2) acceptable risks related to residual (non-impacting) risks or failure modes. The innovative contribution is in how these two profiles can be used to determine a risk-threshold that is completely problem-specific and risk-assessment team-independent. The cumulative curve and/or the RPN profile are modelled and then with a signal processing technique characteristic points are identified, namely the location of the deceleration of RPN values and therefore the location of the threshold specific of a particular process and control strategy. Ranking inconsistencies will stretch the Y-axis but not affect the X-axis and the failure mode distribution—viz., the definition of the last failure mode that is relevant and that as such must be included in risk mitigation efforts, can be done anywhere in the lifecycle even if the RA team changes.

Key innovative aspects are therefore (1) the possibility of trending threshold values and use that trend to exercise OPV and guide CI; (2) for the first time ever, a clear rationale to show to authorities regulating the particular industry considered (EMA, FDA or any other following ISO 9001:2015 or ASTM standards).

### FIG. 9

RPN profile and associated severity, occurrence and detectability profiles, over the entire ensemble of failure mode, for an initial risk assessment. RPN profiles are modelled and a problem-specific threshold is derived from the fitted model. That threshold can be compared with the threshold set in the corporate Quality Risk Management Plan (QRM Plan). The two values do not need to agree. The identified value (viz., 54) is a rigorous measurement derived from the specific risk profile considered, while the corporate policy (viz., QRM Plan) defines a guiding threshold value. The computed threshold will only change between risk assessments if mitigation actions are implemented and therefore the intrinsic problem nature and associated risks are changed (both above and/or below the previous threshold computed). By having multiple teams assess the same set of failure-modes, an estimation of team-to-team variability can be made and the consistency evaluated. The QRM Plan can prescribe retraining the teams if the computed threshold and the RPN profile differ significantly from team to team for a same problem. For repeated RAs performed over lifecycle (i.e., the risk-management and improvement that will take place during LCM) the computed RPN-threshold (RPN*) should be monotonically decreasing. For a particular company, when its team consistency is derived it will be possible to use the RPN profile shape, its derived threshold and the quantities in both axis (viz., the closest failure mode at which the modelled RPN profile kinks) and manage continuous improvements of the control strategy even when different teams. Similarly, it is possible to monitor statistically the occurrence of specific failure modes and provide all background for a Ongoing Process Verification program (cf. FDA 2011 Stage 3 CPV Guidance and EMA 2014 OPV Guideline).

The innovations we claim in regard to RPN and Pareto profiles are: (1) in the way a threshold can be derived from these profiles that is completely problem-specific, science-based, robust to ranking inconsistencies and robust to RA-team changes; (2) how from that threshold important risks (with an RPN greater or equal to the threshold, RPN*) requiring the definition of mitigation actions can be derived; (3) how residual-risks (i.e., tolerable FMs that make up the ‘tail’ of the Pareto profile) can be defined and defended as acceptable risks and failure modes.

### FIG. 10

Process Ontology Stage III: Continuous improvement during commercial manufacturing.

Risk profiles during commercial manufacturing are repeated on a periodic basis and can be used to identify improvements and prioritize their implementation. KPIs can be used in connection to a cost- or objective-function and combine QRM and performance improvements. Method provides all elements needed for improving control strategies during Stage III, support post-approval change management and CAPA investigations.

Key innovative aspects are therefore the capability of aggregating process history and creating a knowledge-management system for a particular system that can then be expanded for other systems that may share elements or entities. Benchmarking different design options across a large number of systems will create a virtuous innovation cycle and transform organizations into ‘learning-organizations’ striving for excellence.

1. A method for Quality Risk Management throughout the lifecycle of a complex product or process, characterized to be a general method to holistically perform Quality Risk Management of a complex product over the complex system sequence that produces it and throughout the lifecycle of said complex product, capable of:
a. providing a knowledge-management foundation to explain all relevant failure modes that may trigger undesirable quality, safety or performance events;
b. listing and locating all such unwanted-unplanned-uncontrolled events triggers (precedents) whose variability will originate a deviation away from the desired specifications target set;
c. comprehensively reviewing those events, focusing on higher risk ranking events first, their location and potential impact within the system's ontology framework;
d. ranking those events in terms of criticality towards quality or towards a predefined key-performance indicator (risks to business continuity);
e. defining control actions to prevent, mitigate or eliminate observed deviations on quality, safety or performance outcomes;
f. using a particular algorithm to compute the intrinsic risk-threshold for a system, based on which events are high-risk and require a control strategy or low-risk and be tolerated/acceptable;
g. being used iteratively, to perform periodic risk-reviews and support, change management, periodic quality reviews (APQRs), CAPA investigations, OPV and continuous improvement over a system lifecycle;
h. applying major changes in the ontology (i.e., including/removing/changing elements in the system), generating new risk-profiles and driving disruptive improvements on the system leading to reduced-risk designs and systems-operation strategies;
i. providing therefore continuity and the means for transitioning existing systems to a near “quality by design” state, while for new systems the proposed method provides all tools and elements needed to effectively achieve “design-for-manufacturability”.

2. The method according to claim 1, characterized by an event-centric approach to risk management that considers simultaneously product lifecycle (chemical, pharmaceutical or biopharmaceutical) with process topology (production, installation, equipment or supplier process).

3. The method according to claim 1, characterized by tandems of specific tools chosen for particular QRM tasks applied to specific process-related entities and to specific product lifecycle stages (Workflows).

4. The method according to claim 1, characterized by a procedure for building the workflows that follows a top-down approach, starting with the desired quality target product profile.

5. The method according to claim 4, also characterized by trial-and-error designs, or informed first-guesses from subject-matter experts.

6. The method according to claim 4, also characterized by an end-to-end mapping of the entire feedstock-to-product sequence.

7. The method according to claim 4, also characterized by creating design, process qualification or commercial lifecycle ontologies, throughout the identification and listing of all inputs and outputs of processing stages in the manufacturing sequence.

8. The method according to claim 4, also characterized by mapping and analyzing the causality between inputs and outputs per unit operation or for the entire sequence.

9. The method according to claim 4, also characterized by deriving failure modes created from such causality.

10. The method according to claim 4, also characterized by creating risk-ranking and profiling evaluation steps.

11. The method according to claim 4, also characterized by deriving a problem-specific criticality threshold as criteria for selecting failure modes requiring mitigation and active control strategies.

12. The method according to claim 4, also characterized by formulating control action plans.

13. The method according to claim 4, also characterized by monitoring the execution and completion of such plans.

14. The method according to claim 4, also characterized by deriving improvement opportunities.

15. The method according to claim 4, also characterized by documenting all steps with supporting evidence and the decision-making context.

16. The method according to claim 4, also characterized by ensuring future use in same product (periodic risk review) or in comparable products/processes of the enhanced science-based justification obtained and to support decisions related to poorly understood systems for which acceptable residual risks exist.

17. The method according to claim 1, also characterized by tools in workflows being interconnected, creating a seamless integrated method for QRM over lifecycle to identify, assess, rank, propose and manage control or mitigation actions;

18. The method according to claim 17, also characterized by the seamless use of the ontology to perform risk assessment and risk management tasks in the risk tools composing the workflow.

19. The method according to claim 17, also characterized by following up with deployment, monitor improvements produced in the system's risk profile, and provide an evidence- and prior-knowledge driven support to decisions.

20. The method according to claim 1, characterized by further including a method to compare the risk profile of a complex system over lifecycle as changes and mitigation actions are introduced.

21. The method according to claim 1, characterized by including a method to focus on risks, their magnitude of change and actions impacting that change, and their direct effects on product quality and other Key Performance Indicators.

22. The method according to claim 1, characterized by further including a method to benchmark using a risk-based comparison, different process versions, different products and different sites manufacturing the same product with same or different process.

23. The method according to claim 1, characterized by further including a method capable of tracing particular distinct risks that discriminate two systems being benchmarked, back to specific system characteristics, by means of built ontologies for each system, therefore informing future designs or future improvement efforts of one particular design.
